(19) United States
(12) Patent Application Publication
(10) Pub. No.: US 2008/0028238 A1
(43) Pub. Date: Jan. 31, 2008

(54) SELECTIVE POWER-ON OF HARD DISK DRIVES WITHIN AND ACROSS MULTIPLE DRIVE ENCLOSURES AND POWER SUPPLY DOMAINS

(75) Inventors: GREGG S. LUCAS, TUCSON, AZ (US); ROBERT A. KUBO, TUCSON, AZ (US); TOHRU SUMIYOSHI, Yokohama-shi (JP); Yoshihiko TERASHITA, Yamato-shi (JP); Yutaka KAWAI, Tokyo (JP)

Correspondence Address: LAW OFFICE OF DAN SHIFRIN, PC - IBM, 14081 WEST 59TH AVENUE, ARVADA, CO, 80004, US

(73) Assignee: IBM CORPORATION, ARMONK, NY (US)

(21) Appl. No.: 11/460,989

(22) Filed: Jul. 30, 2006

(51) Int. Cl. G06F 1/00

(52) U.S. Cl. 713/300

(57) ABSTRACT

To prevent current inrush from exceeding power limitations of a power supply or a power domain in a multiple disk drive system the drives are powered-on in a controlled sequence. In a multi-drive blade storage subsystem, a subsystem control module inventories the locations of the hard drives in one or more drive enclosure blades and maintains information about the boundaries of one or more power domains. The subsystem control module may direct one of several drive power-on sequences, none of which allow current inrush to exceed the allowable current of each power domain.

### TECHNICAL FIELD

The present invention relates generally to storage subsystems and, in particular, to managing the power-on of hard disk drives in such a subsystem

### BACKGROUND ART

Storage subsystem enclosures housing multiple hard disk drives (HDDs) typically have power supplies which are designed to handle the full current required when power to the enclosure, and therefore to the HDDs, is turned on, even though the momentary inrush current drawn by the HDDs when turned on may be more than twice their normal operating current. For redundancy, a pair of power supply units (PSUs) may be provided. Larger storage subsystem enclosures may include more than one pair of redundant PSUs, with each pair supplying power to a portion of the HDDs, each portion defining a power “domain”. However, the power demands of each domain are still within the capability of a power supply, even during the power-on process.

Blade computing is a relatively recent and fast growing innovation. Various components, such as processors, servers, storage, network switches, power supplies, cooling, etc., are provided on cards (known as “blades”) which plug into a back- or mid-plane slot in a chassis. Blade computing, being self contained and with fewer cables, increases processing density in a more compact and less expensive package than traditional computer systems, such as server farms. In a standard power control procedure, a central management module provides a power-on command to each blade. Such a procedure has been adequate for single blades and double-wide blades (those taking two slots).

An even more recent product, the BladeCenter® from IBM®, incorporates a serial attached SCSI (SAS) storage subsystem in a blade housing. The BladeCenter chassis includes two power domains, each sourced by a redundant pair of power supply units. Each domain provides power to one-half of the installed blades. The SAS storage subsystem includes a pair of RAID controller blades and up to four triple-wide drive enclosure blades. Up to 24 HDDs may be installed in each drive enclosure blade. Although the power requirements for each drive enclosure blade is designed to be within the power requirements of three single blades, when an HOD first spins up, it may draw more than double its maximum operating current. Powering up all HDDs in a BladeCenter would far exceed the power envelope and perturbate the power domain. Consequently, a new power management system is desirable for systems and subsystems such as the BladeCenter storage subsystem.

### SUMMARY OF THE INVENTION

The present invention provides systems and methods to prevent current inrush from exceeding power limitations of a power supply or a power domain in a multiple disk drive system by powering-on the drives in a controlled sequence. In a multi-drive blade storage subsystems a subsystem control module inventories the locations of the hard drives in one or more drive enclosure blades and maintains information about the boundaries of one or more power domains. The subsystem control module may direct one of several drive power-on sequences, none of which allow current inrush to exceed the allowable current of each power domain.

### BRIEF DESCRIPTION OF THE DRAWINGS

FIGS. 1A and 1B are front and rear perspective views, respectively, of a blade chassis in which the present invention may be implemented;

FIG. 2 is a perspective view of a disk enclosure blade which may be inserted into the chassis of FIGS. 1A and 1B;

FIG. 3 is a cut-away view of a multi-drive tray which may be inserted into the disk enclosure blade of FIG. 2;

FIG. 4 schematically illustrates power domains in a blade storage subsystem;

FIG. 5 is a more detailed block diagram of the power domains of FIG. 4 within a blade storage subsystem;

FIG. 6 illustrates the power distribution within one drive enclosure blade; and

FIG. 7 is a block diagram of a blade storage subsystem in which the present invention may be implemented.

### DETAILED DESCRIPTION OF THE PREFERRED EMBODIMENT

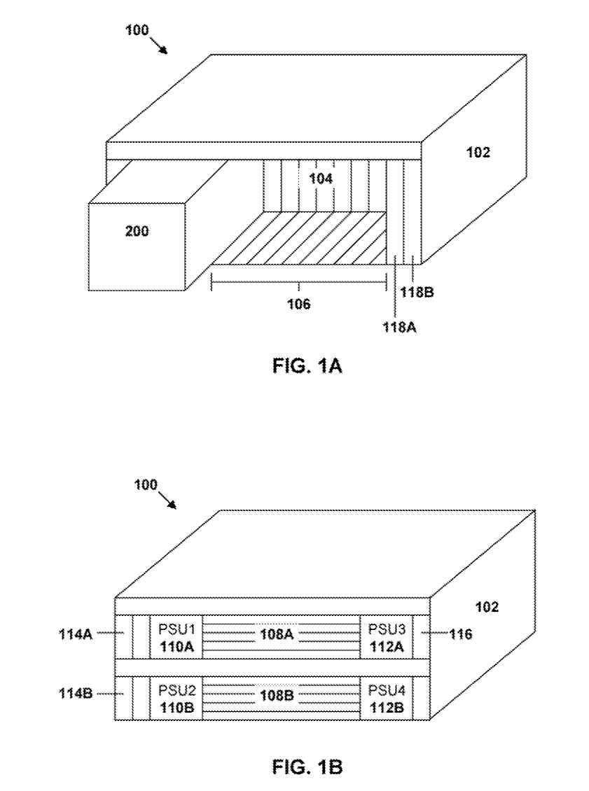

FIGS. 1A and 1B are front and rear perspective views, respectively, of a blade chassis 100 in which the present invention may be implemented. The chassis 100 includes a housing 102 a mid- or back-plane 104 and slots 106 into which blades, such as a drive enclosure blade (DEB) 200, are inserted from the front (FIG. 1A) to mate with appropriate connectors on the front of the mid-plane 104. The IBM eServer# BladeCenter chassis includes fourteen such slots in accessible from the front. The rear of the chassis 100 (FIG. 1B) is configured to hold additional components or modules. Such modules may include, for example, two blowers 108A, 108B, up to two redundant pairs of power supply units (PSUs) 110A, 110B, 112A, 112B, a redundant pair of serial attached SCSI (SAS) switches 114A, 114B, and a management module 116. Such components are inserted from the rear of the chassis 100 to mate with appropriate connectors on the rear of the mid-plane 104.

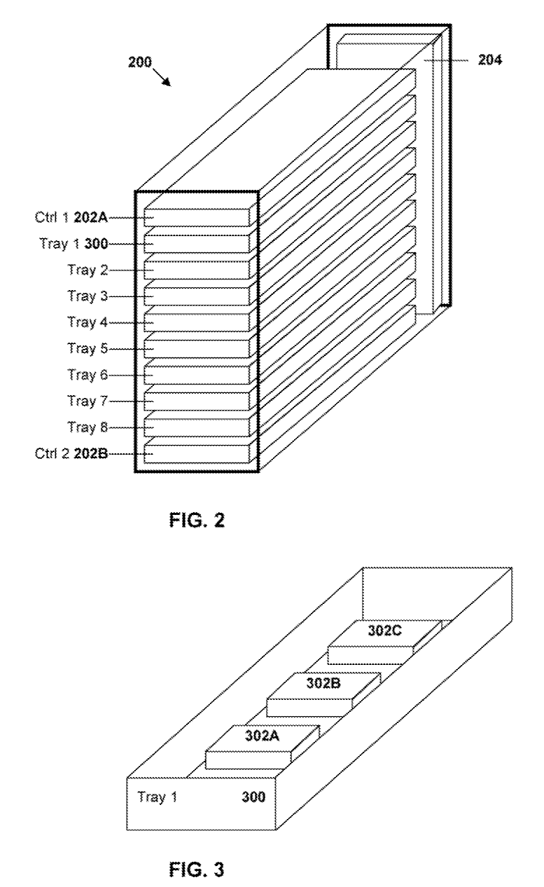

FIG. 2 is a perspective view of a DEB 200 which may be inserted into the chassis 100. Each DEB 200 fits into three contiguous slots 106 in the chassis 100 and up to four DEBs 200 may be installed in the chassis 100. In addition, a redundant pair of RAID controller blades (RCBs) 118A, 118B may be installed in the chassis 100. Up to eight multi-drive trays 300 may be inserted into slots in the DEB 200 along with a redundant pair of local drive controller cards 202A, 2028. The multi-drive trays 300 and controller cards 202A, 202B mate with appropriate connectors on a back-plane 204 within the DEB 200. As illustrated in the cut-away view of FIG. 3, a multi-drive tray 300 may house up to three hard disk drives (HDDs) 302A, 302B, 302C. Thus, each DEB 200 may house up to twenty-four HDDs and a full chassis 100 may house up to ninety-six HDDs.

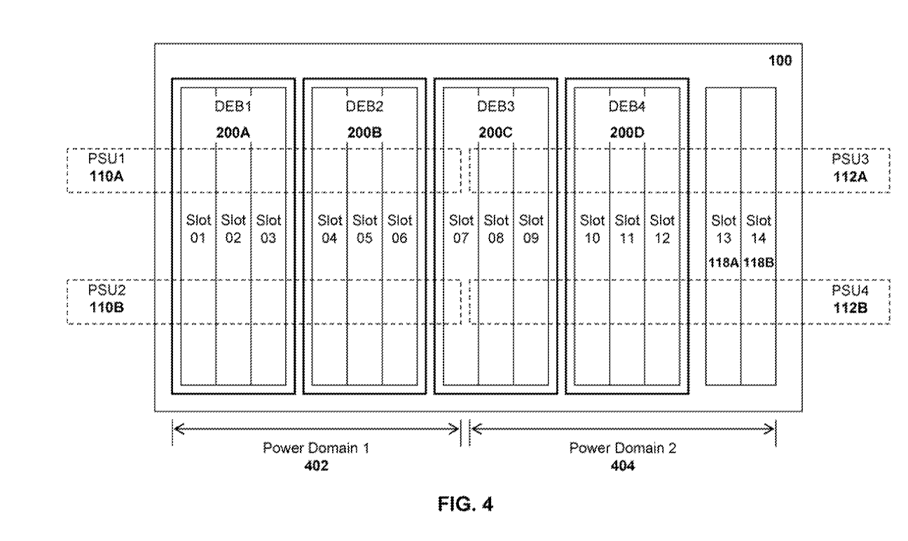

FIG. 4 schematically illustrates subsystem power domains in the blade storage subsystem. A first pair of redundant power supply units, PSU1 110A and PSU2 110B, comprise a first subsystem power domain 402 supplying power to slots 1-7 in the chassis 100. A second pair of redundant power supply units, PSU3 112A and PSU4 1128 comprise a second subsystem power domain 404 supplying power to slots 8-14. If one of the PSUs in a domain fails, service will be continued by the other PSU, thereby ensuring uninterrupted operation. In the illustrated configuration, DEB1 and DEB2 200A, 200B, are wholly within the first subsystem power domain 402 and DEB4 200D and the two RCBs 116A, 116B are wholly within the second subsystem power domain 404. DEB3 200C, in slots 7-9, spans both subsystem power domains 402, 404.

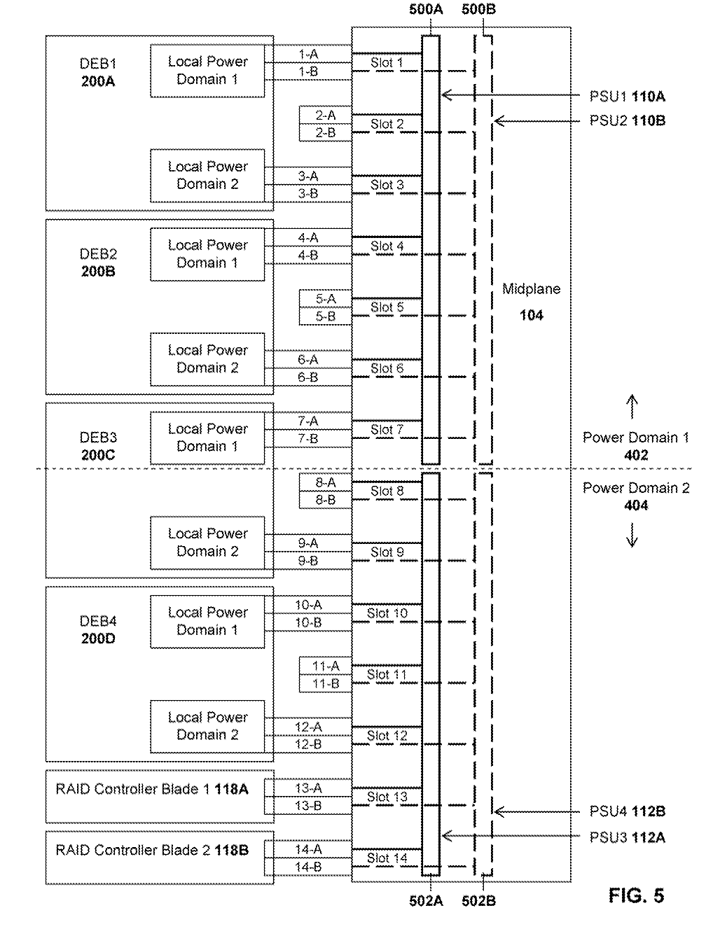

FIG. 5 is a more detailed block diagram of the subsystem power domains 402, 404. As previously described each PSU 110A, 110B, 112A, 112B connects to the rear of the mid-plane 104 while the DEBs 200A-200D connect to the front of the mid-plane 104. The mid-plane 104 includes two pairs of parallel power buses, one pair for each subsystem power domain 402, 404. PSU1 110A is coupled to a first power bus 500A and PSU2 110B is coupled to a second power bus 500B and PSU3 112A is coupled to a third power bus 502A and PSU4 112B is coupled to a fourth power bus 502B. In the front slots 106, each DEB 200 includes four power connectors with which to couple to the mid-plane 104. In DEB1 200A, the first two power connectors 1A, 1B are coupled to PSU1 110A and PSU2 110B, respectively and are part of a first local power domain (within the DES). Similarly, the last two power connectors 3A, 3B are coupled to PSU1 110A and PSU2 110B, respectively, and are part of a second local power domain. The middle two power connectors 2A, 28 are not used. DEB2 200B is coupled to the first and second power buses 500A, 500B in the same manner, In DEB4 200D, the first two power connectors 10A, 10B are coupled to PSU3 112A and PSU4 1128, respectively, and are part of a first local power domain. Similarly, the last two power connectors 12A, 128 are coupled to PSU3 112A and PSU4 112B, respectively, and are part of a second local power domain. DEB3 200C spans the two subsystem power domains 402, 404; the first two power connectors 7A, 7B are coupled to PSU1 110A and PSU2 110B, respectively, and are part of a first local power domain while the last two power connectors 9A, 9B are coupled to PSU3 112A and PSU4 112B, respectively, and are part of a second local power domain. The two RCBs 118A, 118B in chassis slots 13 and 14 are within the second subsystem power domain 404 and are each coupled to power buses 502A, 502B. RCB1 118A is coupled through power connectors 13A and 138 and RCB2 118B is coupled through power connectors 14A and 148. It will be appreciated that the illustrated configuration is only one example and that the present invention contemplates other configurations.

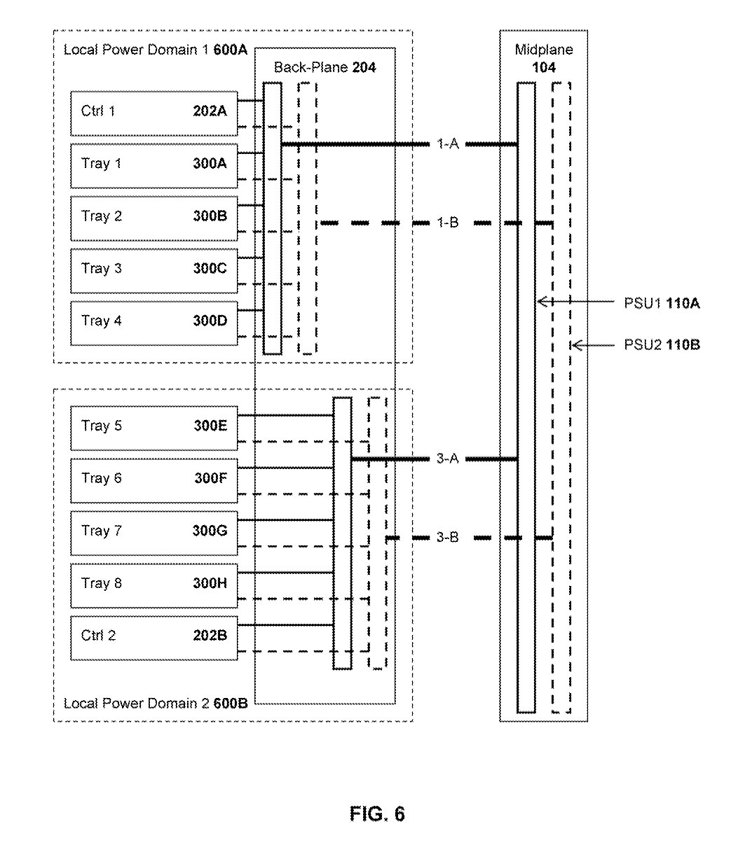

FIG. 6 illustrates the power distribution within one DEB, such as DEB1 200A. Four of the multi-drive trays 300A-300D and one local drive controller card 202A are within a first local power domain 600A and the other four multi-drive trays 300E-300H and the other local drive controller card 202B are within a second local power domain 600B. Although both local power domains 600A, 600B in DEB1 200A are part of the first subsystem power domain 402, in DEB3 200C, the first local power domain 600A would be part of the first subsystem power domain 402 and the second local power domain 600B would be part of the second subsystem power domain 404.

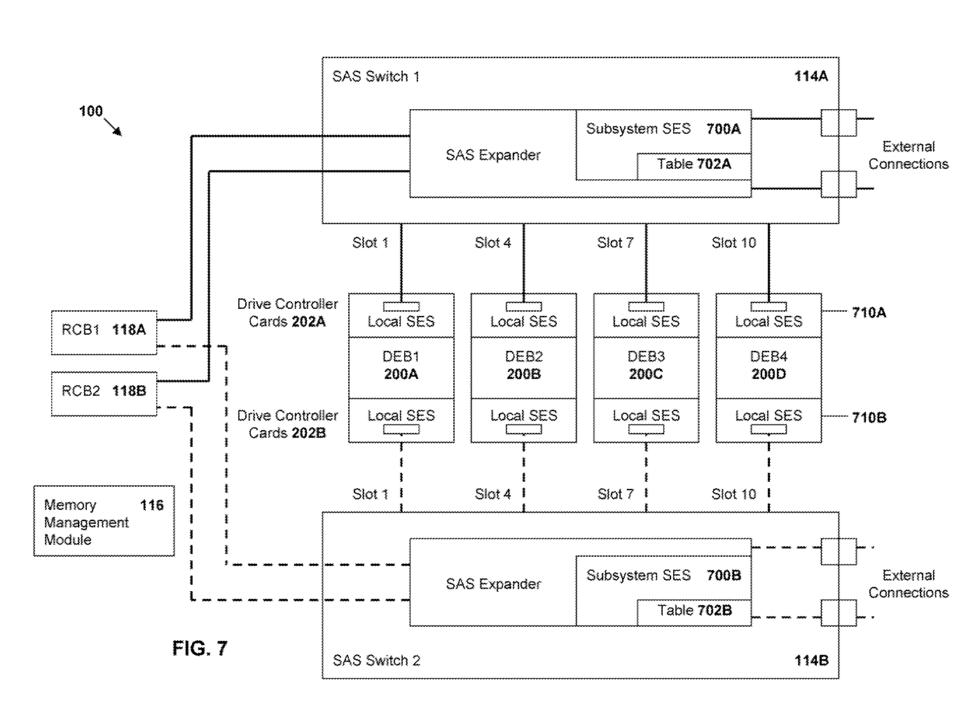

FIG. 7 is a block diagram of a blade storage subsystem in which the present invention may be implemented. In addition to the previously described components, the blade storage subsystem includes redundant subsystem SCSI enclosure services (SES) modules 700A, 700B (collectively referred to hereinafter as subsystem SES module 700) within the two SAS switches 114A, 114B and a local SES module 710A, 710B within each local drive controller card 202A, 202B, respectively (and collectively referred to hereinafter as local SES module 702). The subsystem SES modules 700A, 700B and the local SES modules 710A, 710B include logic for managing the power-on of multiple HDDs in the storage subsystem.

In operation, when the subsystem is powered on, such as with a power switch on the chassis 100, the management module 116 transfers control of the power-on sequence to the subsystem SES module 700. The subsystem SES module 700 performs a discovery operation to determine how many HDDs are installed and where each is located. The location includes the location of the multi-tray module in which each HDD is installed and the location of the DEB in which the multi-tray module is installed. The location also includes the power domain in which each HDD is located. The location information is captured in a table 702 or other comparable data structure within the subsystem SES 700. Such a table may be generated the first time the subsystem is powered on and updated each time a module is inserted or removed from the chassis 100. Alternatively, the table may be generated during each power-on sequence. During the discovery operation, each local SES 710 reports the mapping of SAS port addresses to physical addresses within its DEB. The subsystem SES 700 then compiles the mapping information from the local SES modules 710 into the table 702 along with information about power domain boundaries.

The subsystem SES 700 then directs the local SES modules 710 to commence powering on the HDDs in such a way that the inrush current does not exceed the limits of any power domain. In one such sequence, the subsystem SES 700 directs specific DEBs to power-on specific HDDs in a predefined order, again established such that the inrush current does not exceed the limits of any power domain. This procedure may be particularly beneficial when a DES spans two power domains. In an alternate sequence, the subsystem SES 700 directs one local SES module 710 in each power domain to power-on the HDDs in the respective DEBs. When those two local SES modules 710 report back that the HDDs are powered on, the subsystem SES 700 directs another local SES module 710 in each power domain to power-on the HDDs in the respective DEBs. The process continues until all HDDs are powered on. In a variation of the latter process, depending upon the power domain configuration and current limitations, the subsystem SES 700 may direct more than one local SES module 710 in each power domain to power-on the HDDs. For example, in a two domain system illustrated in the Figs., powering-on the HDDs in two DEBs at the same time in the same power domain may exceed the power limits of a domain. However, the subsystem SES 700 may instead direct DEB1 and DEB4 200A, 200D, in power domains 1 and 2 402, 404, and DEB3 200C, spanning the two power domains 402, 404, to power-on the respective HDDs.

In addition, each local SES module 710 may power-on fewer than all of the HDDs at a time in a DEB 200 if powering on all would exceed the power limits of the domain. In an alternative sequence powering-on of DEBs may be partially overlapped to speed the entire process. Once the initial power spike of one DEB has dissipated, the next DEB may be powered-on with little risk of exceeding power restrictions.

The present invention also accommodates the process of hot-plugging one or more DEBs or drive trays. It will be appreciated that hot-plugging a module can generate the same power surge that a convention power-on can generate. Consequently, in response to a signal that one or more DEBs or drive trays have been hot-plugged, the subsystem SES module 700 directs the appropriate local SES module 710 to power on the new DEBs or drives in such a manner that the power limits are not exceeded.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable media include recordable-type media such as a floppy disk, a hard disk drive, a RAM, and COD-ROMs and transmission-type media such as digital and analog communication links.

The description of the present invention has been presented for purposes of illustration and description, but is not intended to be exhaustive or limited to the invention in the form disclosed. It will be appreciated that the present invention is not limited to use with a subsystem of the foregoing description. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a computer program product containing instructions for managing the power-on of multiple hard disk drives in a storage subsystem.

What is claimed is:

1. A method for managing the power-on of multiple hard disk drives (HDDS) in a storage subsystem, each HDD being housed within one of at least one drive enclosure module and being associated with a power domain within the subsystem, the method comprising:
receiving a signal to power-on the HDDs in the subsystem;
accessing a table identifying the location of each HDD in the system, the location including the identity of a drive enclosure module in which each is housed and the power domain with which each HDD is associated; and
directing each drive enclosure module to power-on the housed HDDs.

2. The method of claim 1, further comprising, prior to accessing the table, performing a discovery operation to identify the number and location of each HDD in the subsystem and generating the table.

3. The method of claim 1, wherein directing each drive enclosure module to power-on the housed HDDs comprises directing one or more drive enclosure modules at a time to power-on the housed HDDs whereby current drawn by the HDDs remains within a maximum current limitation of each power domain.

4. The method of claim 3, further comprising directing each drive enclosure module to power-on one or more selected HDDs at a time within the drive enclosure module.

5. The method of claim 1, wherein directing each drive enclosure module to power-on the housed HDDs comprises directing one drive enclosure module in each power domain at a time to power-on the housed HDDs whereby current drawn by the HDDs remains within a maximum current limitation of each power domain.

6. The method of claim 1, wherein directing each drive enclosure module to power-on the housed HDDs comprises:
directing a first drive enclosure module to power-on;
waiting until a resulting current spike dissipates; and
directing a second drive enclosure module to power-on.

7. A storage subsystem, comprising:
at least one redundant pair of power supply units (PSUs);
at least one pair of power buses corresponding to the at least one pair of redundant PSUs, a first of each redundant pair of PSUs coupled to provide power to a first of the corresponding pair of power buses and a second of each redundant pair of PSUs coupled to provide power to a second of the corresponding pair of power buses, each pair of power buses defining a power domain;
a plurality of slots to receive modules, each slot redundantly coupled to both buses in a power domain whereby power is receivable from both PSUs of a redundant pair of PSUs;
at least one drive enclosure module: each drive enclosure module inserted into one or more slots and comprising a plurality of hard disk drives (HDDS), each HDD being associated with a power domain and redundantly coupled to both buses in the power domain whereby power is receivable from both PSUs of a redundant pair of PSUs;
a master power controller coupled to the drive controller in each drive enclosure module, the master power controller comprising:
means for receiving a power-on signal,
a table identifying the location of each HDD in each drive enclosure module, including the identity of the power domain with which each HDD is associated; and
means for transmitting a command to each drive enclosure module to power-on the associated HDDs; and
each drive enclosure module further comprising a local power controller, responsive to the command from the master power controller for powering on the associated HDDs.

8. The storage subsystem of claim 7, wherein the master power controller comprises a SCSI enclosure services (SES) component within a serial attached SCSI (SAS) switch.

9. The storage subsystem of claim 7, wherein:
the HDDs comprise a RAID array; and
the master power controller comprises an SES component within a RAID controller.

10. The storage subsystem of claim 7, wherein the local power controller comprises a local SES component.

11. The storage subsystem of claim 7, wherein:
the storage subsystem comprises blade architecture;
the master power controller is selected from a group comprising an SES component within an SAS switch and an SES component within a RAID controller, and
the local power controller comprises a local SES component.

12. The storage subsystem of claim 7, wherein the command to each drive enclosure module comprises a command directing one local power controller at a time to power-on the associated HDDs whereby current drawn by the HDDs remains within a maximum current limitation of each power domain.

13. The storage subsystem of claim 12, wherein the command to each drive enclosure further comprises a command directing the drive enclosure module to power-on one or more selected HDDs at a time within the drive enclosure module.

14. The storage subsystem of claim 7, wherein the command to each drive enclosure module comprises a command directing one local power controller in each power domain at a time to power-on the associated HDDs whereby current drawn by the HDDs remains within a maximum current limitation of each power domain.

15. The storage subsystem of claim 7, wherein the master power controller further comprises means for detecting a hot-plug signal.

16. A computer program product of a computer readable medium usable with a programmable computer, the computer program product having computer-readable code embodied therein for managing the power-on of multiple hard disk drives (HDDs) in a storage subsystem, each HDD being housed within one of at least one drive enclosure module and being associated with a power domain within the subsystem, the computer-readable code comprising instructions for:
receiving a signal to power-on the HDDs in the subsystem;
accessing a table identifying the location of each HDD in the system, the location including the identity of a drive enclosure module in which each is housed and the power domain with which each HDD is associated; and
directing each drive enclosure module to power-on the housed HDDs.

17. The computer program product of claim 16, the computer-readable code further comprising instructions for performing a discovery operation to identify the number and location of each HDD in the subsystem and generating the table prior to accessing the table.

18. The computer program product of claim 16, wherein the instructions for directing each drive enclosure module to power-on the housed HDDs comprise instructions for directing one drive enclosure module at a time to power-on the housed HDDs whereby current drawn by the HDDs remains within a maximum current limitation of each power domain.

19. The computer program product of claim 18, the computer-readable code further comprising instructions for directing each drive enclosure module to power-on one or more selected HDDs at a time within the drive enclosure module.

20. The computer program product of claim 16, wherein the instructions for directing each drive enclosure module to power-on the housed HDDs comprise instructions for directing one or more drive enclosure modules in each power domain at a time to power-on the housed HDDs whereby current drawn by the HDDs remains within a maximum current limitation of each power domain.
